(19) United States
(12) Patent Application Publication
(10) Pub. No.: US 2009/0008226 A1
(43) Pub. Date: Jan. 8, 2009

(54) Motion switch

(76) Inventor: Norishige Yamaguchi, Chiba-shi (JP)

Correspondence Address: BRUCE L. ADAMS, ESQ.;ADAMS & WILKS, SUITE 1231, 17 BATTERY PLACE, NEW YORK, NY, 10004, US

(21) Appl. No.: 12/215,174

(22) Filed: Jun. 25, 2008

(30) Foreign Application Priority Data
Jul. 4, 2007 (JP) 2007-176232

(51) Int. Cl. H01H 35/14

(52) U.S. Cl. 200/61.45 R

(57) ABSTRACT

There is provided a mechanical motion switch whose structure is simple, which is a microminiature, which can be used for a long time even in a such a severe environment as a high temperature state, and whose reliability is high. A ceramic-made pedestal of an approximately rectangular shape is fixed to a board and, in the pedestal, there is formed a reverse L-letter shape groove continuous with a base end face and an upside face. A high elasticity wire having an electrical conductivity is fitted and fixed to the groove while being bent, and has a lead penetrating through the board and an arm part extended in a direction horizontal to the board, and a tip part of the arm part is made an action end. In the action end, there is formed, in a position separated from the board, a metal-made deadweight movable by a swing by an elasticity of the arm part. On the board just below the deadweight, there is provided a contact having the electrical conductivity, which is support-fixed to the board by a lead. And, the pedestal, the arm part, the deadweight and the contact are covered by a case.

### BACKGROUND OF THE INVENTION

1. Field of the Invention

The present invention relates to a mechanical microminiature motion switch.

2. Background Art

In recent years, in combination with an increasing propagation of a vehicle and techniques for miniaturizing electronic equipment and increasing a performance of the same, a high performance electronization like a driving support system of the vehicle, such as an ABS (Anti Lock Brake System) and a sideslip prevention system, starts to rapidly proceed. In such situations, it becomes increasingly important to save also an electric power of the electronic equipment for the vehicle and, therefor also as to a motion switch actuating the electronic equipment from a time at which the vehicle started to move, it is demanded to be increasingly miniaturized and increased in its performance. Hitherto, as the motion switch, there are contrived a motorized system, a strain gauge system, a piezoelectric system, a piezoresistance system, an electrostatic capacity system, a thermodetection system and the like and, among them as small ones, there are enumerated the piezoresistance system, the electrostatic capacity system, and the thermodetection system. And, e.g., there is proposed a semiconductor acceleration sensor in which an influence by a temperature change is small. As these ones, there is also a three-axis acceleration sensor, and it is called MEMS (micro electro mechanical systems) because an acceleration detection mechanism is made by a semiconductor process.

On the other hand, from olden times, there are contrived the mechanical motion switches of various mechanisms, and one part of them is adopted also as the motion switch of the electronic equipment for the vehicle. And, e.g., there is proposed an acceleration switch which is small and whose manufacture is easy. In the small acceleration switch, there are disposed a metal container, an inertia sphere which is disposed in the metal container and smaller than an inner diameter of the metal container, and a movable contact which has an elastic force holding, between the metal container and the inertia sphere, the inertia sphere on which no acceleration is exerted while being separated from an inner face of the metal container, and which does not contact with the inner face of the metal container. And, there is made such that, if the acceleration exceeding a predetermined value is exerted on the inertia sphere, the inertia sphere presses the movable contact by an inertia to thereby cause it to contact with the metal container, and the acceleration is detected by conducting between the movable contact and the metal container.

By the way, in the MEMS such as the semiconductor acceleration sensor, since a motion detection mechanism is a semiconductor as mentioned above, as a reliability in a severe environment such as a high temperature state like a vicinity of an engine of the vehicle or an inside of a tire, there is such an issue that the MEMS falsely operate by undergoing an influence of a heat or the like. Further, in the MEMS, since a detection mechanism is the semiconductor in comparison with a pure mechanical system, there is a limitation in simplifying a structure, so that there is such a problem that, in order to microminiaturize the MEMS, there becomes necessary an expensive semiconductor manufacturing facility whose accuracy is high correspondingly.

Further, from olden times, although there are contrived the mechanical motion switches of various mechanisms, it is an actual situation that there is scarcely contrived one of such a mechanism as to be capable of being miniaturized than the MEMS as a size. Additionally, there is an issue that the small acceleration switch is complicated in its mechanism of components, so that its manufacture and assembly take time and effort.

The invention is one made in order to solve the above issues, and its object is to provide a mechanical motion switch whose structure is simple, which is the microminiature, which can be used for a long time even in a such a severe environment as the high temperature state, and whose reliability is high.

### SUMMARY OF THE INVENTION

A motion switch of the invention comprises a board;

a contact having an electrical conductivity and disposed on the board; a pedestal fixed to a position, on the board, separated from the contact; an elastic body having the electrical conductivity, a base end part of the elastic body fixed to the board, and a tip end part of the elastic body extended from the pedestal in a direction parallel to the board; a lead electrically connected to the elastic body; a deadweight having the electrical conductivity, provided in the tip end part of the elastic body, and disposed in a position separating from the contact or a position contacting with the contact; and a case covering, on the board, at least the contact, the elastic body and the deadweight.

In the invention, the lead is one in which the elastic body is extended, and the deadweight is formed from the elastic body.

Further, in the invention, for the elastic body, there may be used a wire material or a plate material.

In the invention, a material of the elastic body is an elastic material having properties of 206-225 GPa in its longitudinal elastic coefficient, and 80.4-83.3 GPa in its transverse elastic coefficient.

In the invention, a material of the elastic body contains, in its composition by weight ratio, at least C≦0.05%, Ni 15-18%, Cr 10-14%, Mo 3-5%, W 3-5%, Co 35-40%, Fe 10-30%, Al 0.01-0.5%, and Si, Mn, Ti each 0.1-5%.

In the invention, a material of the elastic body contains, in its composition by weight ratio, at least C≦0.05%, Ni 31-34%, Cr 19-21%, Mo 9-11%, Co 35-40%, Fe 10-30%, and Si, Mn, Ti, Nb each 0.1-5%.

In the invention, the elastic body is support-fixed to a groove formed in the pedestal.

Further, in the invention, the pedestal possesses one base end face within side faces which are perpendicular to the board, and an upside face which is parallel to the board and continuous with the base end face; and the groove is formed continuously with the base end face and the upside face.

If the invention is used, since the motion switch is constituted by the elastic body having the deadweight, the pedestal, the case and the lead, and each of these components is simple in its shape except the elastic body having the deadweight, each component can be manufactured in a small size. Accordingly, each component is small and simple in its structure, and it is possible to manufacture the motion switch of the microminiature as a whole constitution. Further, by the lead, it is possible to easily mount the motion switch to the board. Further, since the elastic body is extended in the direction parallel to the board, a height of the motion switch in regard to the board can be lowered.

And, by the structure like this, at a stationary time of the motion switch, the deadweight is held in a predetermined position by an elasticity of the elastic body. Further, when a predetermined acceleration swinging the deadweight in a predetermined direction is applied to the motion switch, the deadweight moves from the predetermined position while resisting against the elasticity of the elastic body, thereby changing an electrical contact state with the lead to a state different from the stationary time. As a result, the motion switch can detect an acceleration on the basis of the change in the electrical contact state.

According to the invention, the deadweight can be formed in a tip part of the elastic body by a simple header working or the like, and a portion from the lead to the deadweight can be formed by one elastic body. Further, as the constitution of the motion switch, by the fact that the elastic body functions also as the lead, a contact with the board to which the motion switch is mounted can be facilitated. Accordingly, there can be made the structure of the motion switch whose structure is simple and in which the number of components is small.

According to the invention, by using a wire material, the deadweight can be easily formed in the tip part of the elastic body with the header working being facilitated.

According to the invention, by using a plate material, it is possible to limit in some degree a swinging direction of the deadweight provided in the tip part of the elastic body, so that it is possible to increase an accuracy of the motion switch.

According to the invention, for a material of a spring, there is used an elastic material having properties of 206-225 GPa in longitudinal elastic coefficient, and 80.4-83.3 GPa in transverse elastic coefficient. As a result, the spring using this material accurately operates in comparison with a piano wire, a stainless for a spring material, beryllium-copper, and the like, which are generally used, and can maintain a predetermined elasticity for a long time.

According to the invention, in comparison with the piano wire, the stainless for the spring material, beryllium-copper, and the like, which are generally used as the spring material, since the elastic body is small in its change in modulus of elasticity by temperatures, it accurately operates even if used in a place becoming a high temperature environment such as the vicinity of the engine or the inside of the tire. Further, as to this elastic body, since an elastic fatigue is difficult to occur, a life can be prolonged as well.

According to the invention, it is possible to facilitate the support-fixation of the elastic body by the pedestal.

According to the invention, it is possible to facilitate the support-fixation of the elastic body by the pedestal, and a disposition position of the elastic body as the lead can be easily determined as well.

### BRIEF DESCRIPTION OF THE DRAWINGS

FIG. 1 is a perspective view showing an internal structure of a motion switch of the invention;

FIGS. 2A and 2B are views showing an operation of the motion switch of the invention, wherein FIG. 2A is a sectional view explaining a state in which a deadweight and a contact are separated, and FIG. 2B a sectional view explaining a state in which the deadweight and the contact are contacted;

FIG. 3 is a perspective view showing the internal structure of the motion switch of the invention;

FIGS. 4A and 4B are views showing the operation of the motion switch of the invention, wherein FIG. 4A is a sectional view explaining the state in which the deadweight and the contact are separated, and FIG. 4B a sectional view explaining the state in which the deadweight and the contact are contacted; and

FIG. 5 is a table in which there are compared respective temperature characteristics and durabilities of embodiments of the motion switches of the invention and comparative examples.

### DETAILED DESCRIPTION OF THE INVENTION

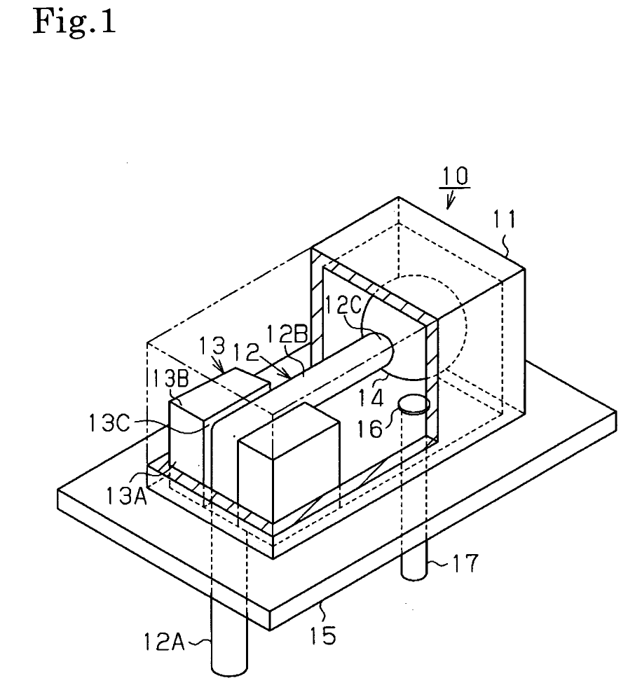

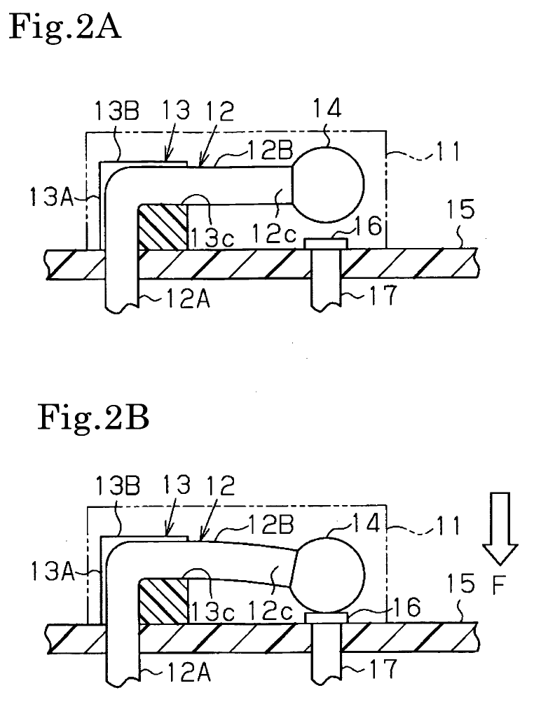

Hereunder, a first implementation mode in which the invention was embodied is explained in compliance with FIG. 1 and FIGS. 2A and 2B.

In FIG. 1, a motion switch 10 is a mechanical microminiature switch attached to a board 15 made of a lamination layer in which copper is coated on a paper-phenol resin.

Onto the board 15, there is fixed a pedestal 13 made of a ceramic of an approximately rectangular shape.

The pedestal 13 has a base end face 13A perpendicular to the board 15, and an upside face 13B horizontal to the board 15. In the pedestal 13, there is concavely provided a groove 13C formed in a reverse L-letter shape, i.e., continuously formed over the base end face 13A and the upside face 13B.

To the groove 13C, there is fitted and fixed a high elasticity wire 12 as an elastic body, which is bent along the groove 13C. The high elasticity wire 12 is extended to a direction of the board 15 from the base end face 13A, and has a lead 12A which penetrates through the board 15 and is connection-supported to the board 15. Further, the high elasticity wire 12 has an arm part 12B extended in a direction horizontal to the board 15 from the upside face 13B, and a tip part of its arm part 12B is made an action end 12C.

In the action end 12C, there is monolithically formed a deadweight 14 made of metal. The deadweight 14 is held in a predetermined position separated from the board 15 by an elasticity of the arm part 12B. Further, the deadweight 14 is made swingable by the elasticity of the arm part 12B, i.e., constituted so as to be movable in a direction of the board 15.

Above the board 15 and just below the deadweight 14, there is possessed a contact 16 having an electrical conductivity. The contact 16 is electrically connected and fixed to a lead 17. The lead 17 penetrates through the board 15, and is connected to the board 15 and support-fixed to the same. That is, the contact 16 is support-fixed to the board 15 by the lead 17.

Accordingly, usually, the deadweight 14 is held in a position separated from the contact 16 by the elasticity of the arm part 12B. Further, if a force in a contact 16 direction is exerted on the deadweight 14, the deadweight 14 moves in the contact 16 direction while resisting against the elasticity of the arm part 12B. And, there is made such that, if a force exceeding a predetermined value is applied to the deadweight 14, the deadweight 14 moves till a position contacting with the contact 16 while resisting against the elasticity of the arm part 12B.

That is, as shown in FIG. 2A, there is made such that, if the motion switch 10 is stationary, the deadweight 14 is held in the position separated from the contact 16, so that the lead 12A and the lead 17 are electrically not contacted. Further, as shown in FIG. 2B, there is made such that, if a predetermined acceleration F is exerted downward on the deadweight 14, the deadweight 14 causes the arm part 12B to bend and, by causing its surface to contact with the contact 16, the lead 12A and the lead 17 are electrically connected.

On an upper face of the board 15, a box-shaped case 11 of heat-resistant resin or the like covers the pedestal 13, the arm part 12B, the deadweight 14 and the contact 16. There is made such that, by covering the arm part 12B, the deadweight 14 and the contact 16, the case 11 prevents an object or the like from contacting with the arm part 12B or the deadweight 14 from an outside, thereby suitably moving the deadweight 14 while responding to the acceleration F.

In mentioning detailedly, the case 11 is made of polyamide 66, and formed in 2 mm (millimeter) in length, 4 mm in width, and 2 mm in height. Further, the pedestal 13 is made of alumina, and formed in 1.6 mm in length, 1 mm in width, and 1 mm in height. The high elasticity wire 12 is made of SR 510 of SPRON (Japanese registered trademark of Kabushikikaisha S. I. I. Micro-parts Company), which is a high elasticity material, and made 0.5 mm in wire diameter φ. Further, the deadweight 14 is one manufactured by header-working a tip of the high elasticity wire 12, and a gold plating is applied to its surface with the purpose of decreasing a contact resistance. Incidentally, the SR 510 is a Co-base alloy whose composition is made, by weight %, C 0.03, Si 0.1, Mn 0.5, P 0.02, S 0.02, Ni 31.4-33.4, Cr 19.5-20.5, Mo 9.5-10.5, Nb 0.8-1.2, Ti 0.3-0.7, Fe 1.10-2.10, and the balance Co and small amounts of inevitable impurities. Further, the SR 510 has, as the elastic material, a longitudinal elastic coefficient of 216-225 GPa (22-23×1000 kg/mm²), and has a transverse elastic coefficient of 83.3 GPa (8.5×1000 kg/mm²).

First of all, by the fact that the structure of the motion switch 10 is made the above-mentioned structure, since the component is simple in its shape except the high elasticity wire 12 having the deadweight 14, it becomes easy to manufacture each component in a small size. Incidentally, although also the high elasticity wire 12 having the deadweight 14 is complicated one in regard to other components, it is possible to manufacture such a microminiature component as mentioned above by header-working the tip part of the high elasticity wire 12. Further, since also a whole constitution is similar to a plastic mold crystal resonator whose microminiature type already exists, it is possible to easily manufacture the above-mentioned motion switch 10 of the microminuature of 2 mm in length, 4 mm in width, and 2 mm in height by diverting a manufacturing technique of the plastic mold crystal resonator.

Next, since the high elasticity wire 12 functions also as the lead 12A connected to the board 15, an assemblage can be facilitated by passing through a reflow soldering device or the like after the motion switch 10 is inserted onto the board by an automatic mounter or the like. Further, since the structure of each motion switch 10 is a structure similar to the plastic mold crystal resonator, it is possible to divert the manufacturing technique of the plastic mold crystal resonator as it is, so that it is unnecessary to design a new manufacturing facility.

Moreover, since the dimensions of the motion switch 10 by the invention are 2 mm in length, 4 mm in width and 2 mm in height, and thus a dimension in a board thickness direction is as thin as 2 mm, also a thickness as the whole electronic equipment can be made thin by lowering the height on the board. This becomes one of very important characteristics in an equipment in which the thickness of the electronic equipment itself, such as a tire air pressure monitoring system (TPMS: Tire Pressure Monitoring System), exerts large an influence on an easiness of its attachment. For example, as to the electronic equipment used in the TPMS, in a case where its thickness is thicker than several tens mm, when the tire is assembled by an automatic tire assemblage apparatus (tire mounter) or the like, a fear that it is damaged becomes high.

Finally, by the fact that the high elasticity wire 12 is made the SPRON material, such as SR 100 or SR 510, which is a so-called high elasticity material, it is possible to decrease a change in modulus of elasticity by temperatures in comparison with the piano wire, the stainless for the spring material, beryllium-copper, and the like, which are generally used as the spring material. Therefore, it is possible to supply each motion switch 10 which accurately operates even if used in the place becoming the high temperature environment such as the vicinity of the engine or the inside of the tire, in which the elastic fatigue is difficult to occur, and which endures a long time use even under the severe environment. Incidentally, the SR 100 is a Co-base alloy whose composition is made, by weight %, C 0.03, Si 0.8-1.05, Mn 0.5-1.10, P 0.02, S 0.02, Ni 16.0-17.0, Cr 11.6-12.2, Mo 3.80-4.20, W 3.85-4.15, Co 38.0-39.4, Ti 0.4-0.8, Al 0.04-0.12, and the balance Fe and small amounts of inevitable impurities. Further, the SR 100 has, as the elastic material, the longitudinal elastic coefficient of 206-216 GPa (21-22×1000 kg/mm²), and has the transverse elastic coefficient of 80.4 GPa (8.2×1000 kg/mm²).

By the way, a verification was made by performing an embodiment in which the material of the wire material was altered.

### EMBODIMENT 1

In the motion switch 10 shown in FIG. 1, by an injection molding of the polyamide 66 of 0.2 mm in thickness, the case 11 was molded in 2 mm in length, 4 mm in width, and 2 mm in height. The pedestal 13 was made of alumina, and worked to the dimensions of 1.6 mm in length, 1 mm in width and 1 mm in height, and the groove 13C was formed by applying a groove working to the base end face 13A and the upside face 13B such that the high elasticity wire 12 can be pressure-inserted. As to the high elasticity wire 12, the deadweight 14 was manufactured by header-working the SR 510 material of 0.5 mm in wire diameter φ such that the deadweight 14 contacts with the contact 16 on the board 15 with a stress (in a direction perpendicular to the high elasticity wire 12) of 33 G (G denotes a gravitational acceleration (9.8 m/s²)). Incidentally, to the surface of the deadweight 14, there was applied the gold plating in order to decrease the contact resistance.

By covering these components with the cover 11 like FIG. 1, the motion switch 10 was manufactured.

### COMPARATIVE EXAMPLE 1

Although the comparative example 1 was made a constitution similar to the embodiment 1, the material of the high elasticity wire 12 was made the piano wire.

### COMPARATIVE EXAMPLE 2

Although the comparative example 2 was made the constitution similar to the embodiment 1, the material of the high elasticity wire 12 was made the stainless for the spring material.

### COMPARATIVE EXAMPLE 3

Although the comparative example 3 was made the constitution similar to the embodiment 1, the material of the high elasticity wire 12 was made the beryllium-copper.

And, the motion switches of each of the embodiment 1 and the comparative examples 1-3, which were mentioned above, were manufactured respectively by five pieces, and the verifications mentioned below were performed.

First, about a value of the gravitational acceleration mutually conducting between the lead 12A and the lead 17 of the contact 16 in the motion switch, in order to confirm a fluctuation by a difference in environment temperatures, the value of the gravitational acceleration mutually conducting the lead 12A and the lead 17 of the contact 16 in the motion switch was confirmed in a normal temperature environment and a high temperature environment.

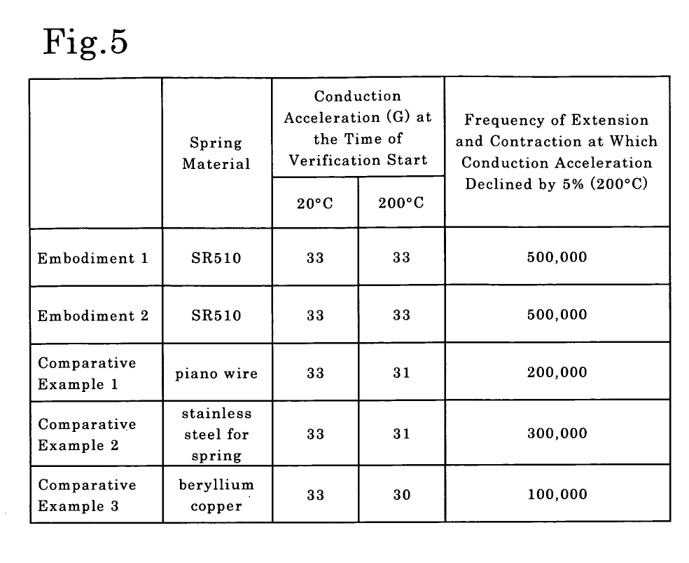

Concretely, under the environments of 20° C. and 200° C., about these four kinds of motion switches, there was inspected each gravitational acceleration value (this value is made a conducting acceleration) in a case where the motion switch conducts, i.e., the deadweight 14 contacts with the contact 16 and thus a conduction is performed between the leads 12A, 17. And, their results are shown in a table 30 of FIG. 5.

Further, in order to confirm the durability of the motion switch in the high temperature environment, about the gravitational acceleration which mutually conducts between the lead 12A and the lead 17 of the contact 16 in the motion switch, there was confirmed a change basing on a frequency in which there was mutually conducted between the two leads 12A, 17, i.e., a vibration frequency of the high elasticity wire 12. Concretely, in the table 30, there is shown a result of an investigation in which, under the environment of 200° C., there was investigated the vibration frequency of the high elasticity wire 12, in which a value of the conducting acceleration at a verification start time decreased by at least 5% in average.

(1) First, as shown in the table 30, it is understood that the conducting accelerations at 20° C. and 200° C. in the embodiment 1 are constant in comparison with the comparative examples 1-3. This is because, in the embodiment 1, for the high elasticity wire 12 there is used the SR 510 which is the high elasticity material, and the elasticity of the SR 510 scarcely changes till about 200° C.

(2) Next, as shown in the table 30, the vibration frequency in which the conducting acceleration at 200° C. in the embodiment 1 decreases by at least 5% is largest in comparison with the comparative examples 1-3. This is because, in the embodiment 1, for the high elasticity wire 12 there is used the SR 510 and, in the SR 510, a metal fatigue by a stress is difficult to accumulate.

Next, advantages of the present implementation mode constituted like the above are described below.

(1) According to the present implementation mode, as the structure of the motion switch 10, the high elasticity wire 12 is disposed, as a point connecting with the board 15, on the pedestal 13 in the form bent at a right angle, and the action end 12C in the tip in a side opposite to its lead 12A has the deadweight 14 made of metal. Further, by making such a structure that an outer periphery is covered by the case 11 of the heat-resistant resin or the like, it is possible to manufacture the motion switch 10 whose structure is simple, which is excellent in a productivity and is the microminiature, and in which a connection with the board is easy as well.

(2) According to the present implementation mode, the material of the high elasticity wire 12 in the motion switch 10 is made the SPRON material which is the so-called high elasticity material such as the SR 100, SR 510. Accordingly, it is possible to manufacture the motion switch 10 which accurately operates even if used in the place becoming the high temperature environment such as the vicinity of the engine or the inside of the tire, and which endures the long time use.

(Second Implementation Mode)

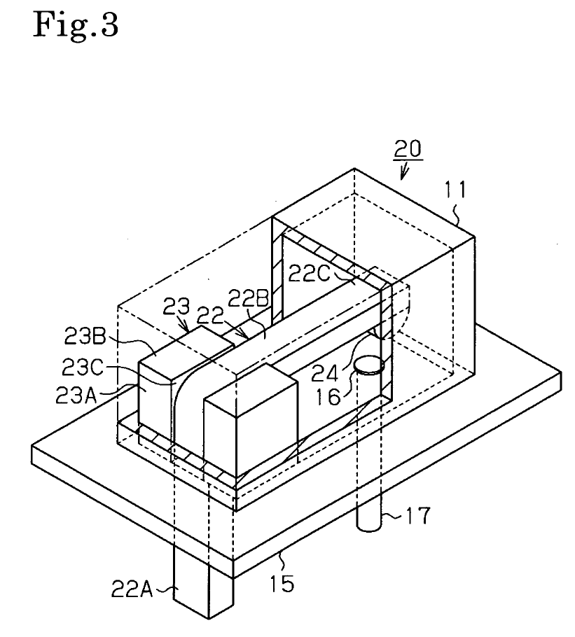

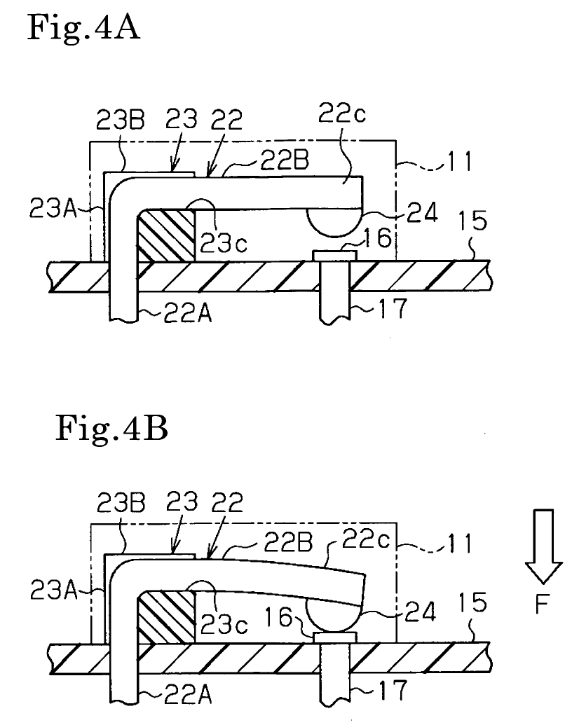

Hereunder, a second implementation mode in which the invention was embodied is explained in compliance with FIG. 3 and FIGS. 4A and 4B.

Incidentally, the present implementation mode is one different in a point that the high elasticity wire 12 in the first implementation mode is made a plate material and, in the below, differentiae are explained while being made a center. Further, the same reference numeral is applied to a member similar to the first implementation mode, and its explanation is omitted.

FIG. 3 is a perspective view showing an internal structure of a motion switch 20 in which the invention was embodied.

In FIG. 3, the motion switch 20 is the mechanical microminiature motion switch attached to the board 15.

Onto the board 15, there is fixed a pedestal 23 made of ceramic of the approximately rectangular shape.

The pedestal 23 has a base end face 23A perpendicular to the board 15, and an upside face 23B horizontal to the board 15. In the pedestal 23, there is concavely provided a groove 23C formed in the reverse L-letter shape, i.e., continuously formed over the base end face 23A and the upside face 23B.

To the groove 23c, there is fitted and fixed a high elasticity plate 22 as the elastic body, which is bent along the groove 23C. The high elasticity plate 22 is extended to the direction of the board 15 from the base end face 23A, and has a lead 22A which penetrates through the board 15 and is connection-supported to the board 15. Further, the high elasticity plate 22 has an arm part 22B extended in the direction horizontal to the board 15 from the upside face 23B, and a tip part of its arm part 22B is made an action end 22C.

In a lower part of the action end 22C, there is monolithically formed a deadweight 24 made of metal. The deadweight 24 is held in the predetermined position separated from the board 15 by the elasticity of the arm part 22B. Further, the deadweight 24 is made swingable by the elasticity of the arm part 22B, i.e., constituted so as to be movable in the direction of the board 15.

Above the board 15 and just below the deadweight 24, there is possessed the contact 16 having the electrical conductivity. The contact 16 is support-connected to the board 15 by the lead 17.

Accordingly, usually, the deadweight 24 is held in the position separated from the contact 16 by the elasticity of the arm part 22B. Further, if the force in the contact 16 direction is exerted on the deadweight 24, the deadweight 24 moves in the contact 16 direction while resisting against the elasticity of the arm part 22B. And, there is made such that, if the force exceeding the predetermined value is applied to the deadweight 24, the deadweight 24 moves till the position contacting with the contact 16 while resisting against the elasticity of the arm part 22B.

That is, as shown in FIG. 4A, there is made such that, if the motion switch 20 is stationary, the deadweight 24 is held in the position separated from the contact 16, so that the lead 22A and the lead 17 are electrically not contacted. Further, as shown in FIG. 4B, there is made such that, if the predetermined acceleration F is exerted downward on the deadweight 24, the deadweight 24 causes the arm part 22B to bend and, by causing its surface to contact with the contact 16, the lead 22A and the lead 17 are electrically connected.

On the upper face of the board 15, the box-shaped case 11 of heat resistant resin or the like covers the pedestal 23, the arm part 22B, the deadweight 24 and the contact 16, and there is made such that the case 11 prevents the object or the like from contacting with the arm part 22B or the deadweight 24 from the outside, thereby suitably moving the deadweight 24 while responding to the acceleration F.

In mentioning detailedly, the pedestal 23 is made of alumina, and formed in 1.6 mm in length, 1 mm in width, and 1 mm in height. Further, the high elasticity plate 22 is made of the SR 510 of the SPRON, which is the high elasticity material, and was made 0.3 mm in thickness and 0.5 mm in breadth. Further, the deadweight 24 is one manufactured by header-working a tip of the high elasticity plate 22, and the gold plating is applied to its surface with the purpose of decreasing the contact resistance.

First of all, by the fact that the structure of each motion switch 20 is made the above-mentioned structure, since the component is simple in its shape except the high elasticity plate 22 having the deadweight 24, it becomes easy to manufacture each component in the small size. Incidentally, although also the high elasticity plate 22 having the deadweight 24 is complicated one in regard to other components, it is possible to manufacture such a microminiature component as mentioned above by header-working the tip part of the high elasticity plate 22. Further, since also the whole constitution is similar to the plastic mold crystal resonator, it is possible to easily manufacture each above-mentioned motion switch 20 of the microminiature of 2 mm in length, 4 mm in width, and 2 mm in height.

Next, since the high elasticity plate 22 functions also as the lead 22A connected to the board 15, the assemblage can be made easy by passing through the reflow soldering device or the like after the motion switch 20 is inserted onto the board by the automatic mounter or the like. Further, since the structure of the motion switch 20 is the structure similar to the plastic mold crystal resonator, it is possible to divert the manufacturing technique of the plastic mold crystal resonator as it is, so that it is unnecessary to design the new manufacturing facility.

Moreover, since the dimensions of the motion switch 20 by the invention are 2 mm in length, 4 mm in width and 2 mm in height, and thus the dimension in the board thickness direction is as thin as 2 mm, also the thickness as the whole electronic equipment can be made thin by lowering the height on the board. This becomes one of very important characteristics in the equipment in which the thickness of the electronic equipment itself, such as the tire air pressure monitoring system, exerts large the influence on the easiness of its attachment.

Finally, by the fact that the high elasticity plate 22 is made the SPRON material, such as SR 100 or SR 510, which is the so-called high elasticity material, it is possible to decrease the change in modulus of elasticity by temperatures in comparison with the piano wire, the stainless for the spring material, beryllium-copper, and the like, which are generally used as the spring material. Therefore, it is possible to supply each motion switch 20 which accurately operates even if used in the place becoming the high temperature environment such as the vicinity of the engine or the inside of the tire, in which the elastic fatigue is difficult to occur, and which endures the long time use even under the severe environment.

By the way, the verification was made by performing an embodiment in which the material of the wire material or the plate material was altered.

### EMBODIMENT 2

In the motion switch 20 shown in FIG. 3, by the injection molding of the polyamide 66 of 0.2 mm in thickness, the case 11 was molded in 2 mm in length, 4 mm in width, and 2 mm in height. The pedestal 23 was made of alumina, and worked to the dimension of 1.6 mm in length, 1 mm in width and 1 mm in height, and the groove 23C was formed by applying the groove working to the base end face 23A and the upside face 23B such that the high elasticity plate 22 can be pressure-inserted. As to the high elasticity plate 22, the deadweight 24 was manufactured by header-working the SR 510 material of 0.3 mm in thickness and 0.5 mm in breadth such that the deadweight 24 contacts with the contact 16 on the board 15 with the stress (in the direction perpendicular to the high elasticity plate 22) of 33 G. Incidentally, to the surface of the deadweight 24, there was applied the gold plating in order to decrease the contact resistance.

By covering these components with the cover 11 like FIG. 3, the motion switch 20 was manufactured.

And, the motion switches of the above-mentioned embodiment 2 were manufactured by five pieces, and the following verifications were performed in addition to the first implementation mode.

First, about the value of the gravitational acceleration mutually conducting between the lead 22A and the lead 17 in the motion switch 20, in order to confirm the fluctuation by the difference in environment temperatures, the value of the gravitational acceleration mutually conducting the lead 22A and the lead 17 in the motion switch 20 was confirmed in the normal temperature environment and the high temperature environment.

Concretely, under the environments of 20° C. and 200° C., about the motion switch 20, there was inspected the conducting acceleration in the case where the motion switch 20 conducts, i.e., the deadweight 24 contacts with the contact 16 and thus the conduction is performed between the leads 22A, 17. And, their results are shown in the table 30 of FIG. 5 while being combined.

Further, in order to confirm the durability of the motion switch 20 in the high temperature environment, about the gravitational acceleration which mutually conducts between the lead 22A and the lead 17 in the motion switch 20, there was confirmed the change basing on the frequency in which there was mutually conducted between the two leads 22A, 17, i.e., the vibration frequency of the high elasticity plate 22. Concretely, in the table 30, there is shown, while being combined, the result of the investigation in which, under the environment of 200° C., there was investigated the vibration frequency of the high elasticity plate 22, in which the value of the conducting acceleration at the verification start time decreased by at least 5% in average.

(1) First, as shown in the table 30, it is understood that the conducting accelerations at 20° C. and 200° C. in the embodiment 2 are constant in comparison with the comparative examples 1-3. This is because, in the embodiment 2, for the high elasticity plate 22 there is used the SR 510 which is the high elasticity material, and the elasticity of the SR 510 scarcely changes till about 200° C.

(2) Next, as shown in the table 30, the vibration frequency in which the conducting acceleration at 200° C. in the embodiment 2 decreases by at least 5% is largest in comparison with the comparative examples 1-3. This is because, in the embodiment 2, for the high elasticity plate 22 there is used the SR 510 and, in the SR 510, the metal fatigue by the stress is difficult to accumulate.

Next, in addition to the advantages of the first implementation mode, advantages of the present implementation mode constituted like the above are described below.

(1) According to the present implementation mode, as the structure of the motion switch 20, the high elasticity plate 22 is disposed, as the point connecting with the board 15, on the pedestal 23 in the form bent at the right angle, and the action end 22C in the tip in the side opposite to its lead 22A has the deadweight 24 made of metal. Further, by making such a structure that the outer periphery is covered by the case 11 of the heat resistant resin or the like, it is possible to manufacture the motion switch 20 whose structure is simple, which is excellent in the productivity and is the microminiature, and in which the connection with the board is easy as well.

(2) According to the present implementation mode, since there is used the high elasticity plate 22 whose sectional shape is a rectangular shape, it is possible to prescribe a direction, along which the deadweight 24 swings, in some degree. Accordingly, it is possible to manufacture the motion switch 20 whose accuracy is higher.

(Other Implementation Modes)

Incidentally, each of the above implementation modes can be implemented in a mode mentioned below as well.

In the above implementation modes, although the high elasticity wire 12 is constituted by a wire-like member, and the high elasticity plate 22 by a plate-like member, the shape of the high elasticity wire 12 or the high elasticity plate 22 is not limited to this.

In the above implementation modes, the deadweight 14 is provided in the tip of the action end 12C, and the deadweight 24 in the tip lower part of the action end 22C. However, it is not limited to this and, so long as each of the deadweights 14, 24 contacts with the contact 16, it may be provided in each of the action ends 12C, 22C in whichever direction and whatever shape.

In the above implementation modes, each of the deadweight 14, 24 is respectively held in the position separated from the contact 16 by each of the action ends 12C, 22C. However, it is not limited to this and, in a case where a predetermined acceleration in a direction reverse to the contact 16 is applied to each of the deadweight 14, 24 by making such that, by approaching each of the action ends 12C, 22C to the contact 16, ordinarily each of the deadweight 14, 24 is respectively contacted with the contact 16, there may be made such that each of the deadweights 14, 24 is respectively separated from the contact 16. If made like this, it is possible to easily detect a failure of the contact between each of the deadweight 14, 24 and the contact 16.

Although the case 11 is formed in the box-like shape by the heat resistant resin or the like, the material and the shape of the case are not limited to these.

Although the pedestal 13 is made of ceramic, it is not limited to this. For example, there may be made such that the pedestal is made of metal, and one part of the pedestal is used as the lead.

Although the board 15 is made of the lamination layer in which copper is coated on the paper-phenol resin, it is not limited to this.

What is claimed is:

1. A motion switch comprising:
a board;
a contact having an electrical conductivity and disposed on the board;
a pedestal fixed to a position, on the board, separated from the contact;
an elastic body having the electrical conductivity, a base end part of the elastic body fixed to the board, and a tip end part of the elastic body extended from the pedestal in a direction parallel to the board;
a lead electrically connected to the elastic body;
a deadweight having the electrical conductivity, provided in the tip end part of the elastic body, and disposed in a position separating from the contact or a position contacting with the contact; and
a case covering, on the board, at least the contact, the elastic body and the deadweight.

2. A motion switch according to claim 1, wherein the lead is one in which the elastic body is extended, and the deadweight is formed from the elastic body.

3. A motion switch according to claim 1, wherein the elastic body is a wire material.

4. A motion switch according to claim 1, wherein the elastic body is a plate material.

5. A motion switch according to claim 1, wherein a material of the elastic body is an elastic material having properties of 206-225 GPa in its longitudinal elastic coefficient, and 80.4-83.3 GPa in its transverse elastic coefficient.

6. A motion switch according to claim 1, wherein a material of the elastic body contains, in its composition by weight ratio, at least C≦0.05%, Ni 15-18%, Cr 10-14%, Mo 3-5%, W 3-5%, Co 35-40%, Fe 10-30%, Al 0.01-0.5%, and Si, Mn, Ti each 0.1-5%.

7. A motion switch according to claim 2, wherein a material of the elastic body contains, in its composition by weight ratio, at least C≦0.05%, Ni 15-18%, Cr 10-14%, Mo 3-5%, W 3-5%, Co 35-40%, Fe 10-30%, Al 0.01-0.5%, and Si, Mn, Ti each 0.1-5%.

8. A motion switch according to claim 1, wherein a material of the elastic body contains, in its composition by weight ratio, at least C≦0.05%, Ni 31-34%, Cr 19-21%, Mo 9-11%, Co 35-40%, Fe 10-30%, and Si, Mn, Ti, Nb each 0.1-5%.

9. A motion switch according to claim 2, wherein a material of the elastic body contains, in its composition by weight ratio, at least C≦0.05%, Ni 31-34%, Cr 19-21%, Mo 9-11%, Co 35-40%, Fe 10-30%, and Si, Mn, Ti, Nb each 0.1-5%.

10. A motion switch according to claim 1, wherein the elastic body is support-fixed to a groove formed in the pedestal.

11. A motion switch according to claim 7, wherein the elastic body is support-fixed to a groove formed in the pedestal.

12. A motion switch according to claim 10, wherein the pedestal possesses one base end face within side faces which are perpendicular to the board, and an upside face which is parallel to the board and continuous with the base end face, and
the groove is formed continuously with the base end face and the upside face.
